(19) United States
(12) Patent Application Publication
(10) Pub. No.: US 2019/0081388 A1
(43) Pub. Date: Mar. 14, 2019

(54) LOW-PROFILE MULTI-BAND ANTENNA

(71) Applicant: Thomson Licensing, Issy-Ies-Moulineaux (FR)

(72) Inventors: Dominique LO HINE TONG, Cesson-Sevigne (FR); Philippe MINARD, Cesson-Sevigne (FR); Lizhi ZHAO, Beijing (CN)

(21) Appl. No.: 16/087,128

(22) PCT Filed: Mar. 21, 2017
(86) PCT No.: PCT/EP2017/056738

§ 371 Date: Sep. 21, 2018

(30) Foreign Application Priority Data
Mar. 23, 2016 (EP) 16305326.7

(51) Int. Cl. H01Q 1/24; H01Q 1/22; H01Q 7/00; H01Q 9/42; H01Q 5/30

(52) U.S. Cl. CPC H01Q 1/243; H01Q 1/2291; H01Q 5/30; H01Q 9/42; H01Q 7/00

(57) ABSTRACT

The invention relates to an antenna system mounted onto a printed circuit board, said antenna system comprising first and second radiating elements, an antenna feeding element connected to an antenna feeding pad of the printed circuit board, a ground return element connected to a ground pad of the printed circuit board. A third radiating element having first and second ends, the first end of the third radiating element is connected to the second end of the second radiating element. The third radiating element, the second radiating element, the ground return element and the antenna feeding element are arranged to form an inverted-F antenna.

### 1. TECHNICAL FIELD

The present invention relates generally to a multi-band antenna for wireless systems, for example for home-networking devices or mobile devices. More specifically, the antenna system of the present invention can be used in set-top boxes, gateways or tablets.

### 2. BACKGROUND ART

Home-networking devices, such as gateways and set-top-boxes, needs to be compatible with a plurality of wireless standards and/or a plurality of operating frequency bands for a given standard. Therefore, these devices need to have antennas designed for operating at different frequency bands. The invention will be more specifically described for WiFi applications. In the framework of this application, the antennas have to address the IEEE.802.11a/b/g/n/ac standards, meaning a dual-band antenna operating in the [2.4-2.5] GHz and [5.15-5.85] GHz bands.

As this antenna is deemed to be put in a box and to be connected to a printed circuit board, different requirements have been defined for this antenna:
use of a 3D antenna metal technology;
low-profile or low-height antenna design;
surface mountable on board (SMD-type) antenna;
stamping process compatible.

The idea of the invention is to design such an antenna from a classical inverted F antenna (IFA), which primary provides a single band operation. An example of IFA fabricated using stamping metal technology is shown in FIGS. 1 and 2. FIG. 1 shows a 2D view of the antenna and FIG. 2 shows a 3D perspective view of the antenna mounted on a Printed Circuit Board (PCB).

In reference to FIGS. 1 and 2, the antenna contains two vertical metal strips 11 and 12 which are both linked on the top end by a horizontal metal strip 10, forming therefore an inverted F shape. Both vertical strips 11 and 12 are terminated by a pin, P11 and P12 respectively, which are dedicated to be inserted in the respective hole drilled in the PCB. The antenna is fed via the pin P12 and the return path to the ground is provided by the pin P11. The horizontal strip 10 is a radiating element, the vertical strip 11 is a ground return element and the vertical strip 12 is a feeding element.

As known by people skilled in the art, the length of the L segment formed by the vertical strip 11 and the horizontal strip 10 is around a quarter of the wavelength, and the distance between the two vertical strips 11 and 12 is tuned commonly in order to achieve the desired impedance matching. FIG. 2 shows how the IFA is mounted onto a PCB, how it is fed by a micro-strip line and how the grounding pin P11 is connected to the PCB ground plane. This antenna operates in the Wi-Fi 2.4 GHz band and total length of the resonating element (the L segment) is around 34 mm.

### 3. SUMMARY OF INVENTION

A purpose of the invention is to create a multi-band antenna exhibiting the following characteristics: stamping process compatible, SMD technology compatible, very low profile, high efficiency.

According to the invention, this antenna is created from a conventional Inverted F antenna (IFA). According to the invention, another resonance frequency is created by increasing strongly the distance between the feeding element and the ground return element of the IFA, achieving thus a dual-band operation.

More specifically, the invention relates to an antenna system mounted onto a printed circuit board, said antenna system comprising:
a first radiating element having first and second ends,
an antenna feeding element connected, at a first end, to the second end of the first radiating element and, at a second end, to an antenna feeding pad of the printed circuit board,
a second radiating element having first and second ends, the first end of the second radiating element being connected to the second end of the first radiating element,
a ground return element connected, at a first end, to the second end of the second radiating element and, at a second end, to a ground pad of the printed circuit board, and
va third radiating element having first and second ends, the first end of the third radiating element being connected to the second end of the second radiating element.

In this embodiment, the third radiating element, the second radiating element, the ground return element and the antenna feeding element are arranged to form an inverted-F antenna.

According to a particular embodiment, the first radiating element, the second radiating element, the antenna feeding element and the ground return element are arranged to form an inverted-F antenna resonating at a first resonant frequency in a first frequency band.

According to a particular embodiment, the antenna feeding element, the second radiating element and the ground return element are arranged to form a loop antenna resonating at a second resonant frequency in a second frequency band, the second frequency band being above the first frequency band.

This antenna operates at least at two operating frequencies, for example at a first frequency in the WiFi band [2.4 GHz-2.5 GHz] and at a second frequency in the WiFi band [5.15 GHz-5.85 GHz]. This antenna is of SMD-type and can be easily manufactured by a stamping process.

According to a particular embodiment, the second radiating element is U-shaped for compactness reason.

According to a particular embodiment, the antenna feeding element and the ground return element are L-bended in order to reduce the height of the antenna system and to achieve a low-profile antenna design.

According to a particular embodiment, the third radiating element, the second radiating element, the ground return element and the antenna feeding element are arranged to form an inverted-F antenna resonating at a third resonant frequency in a third frequency band.

In case of a dual-band antenna, the third resonant frequency is included in the first frequency band i.e. the third frequency band is substantially equal to the first frequency band.

According to a particular embodiment, the third radiating element is L-bended, a portion of the L being parallel to the printed circuit board. It enables to pick and place the antenna by a machine for its connection to the printed circuit board.

According to a particular embodiment, the second end of the first radiating element is connected to an open circuit element soldered to an open circuit pad of the printed circuit board. It can help to better hold in place the antenna on the printed circuit board during the soldering process.

The invention also concerns a device comprising a printed circuit board and an antenna system as defined hereinabove, said antenna system being mounted on said printed circuit board.

### 4. BRIEF DESCRIPTION OF THE DRAWINGS

The invention can be better understood with reference to the following description and drawings, given by way of example and not limiting the scope of protection, and in which:

FIG. 1 is a 2D view of an inverted F antenna of the prior art;

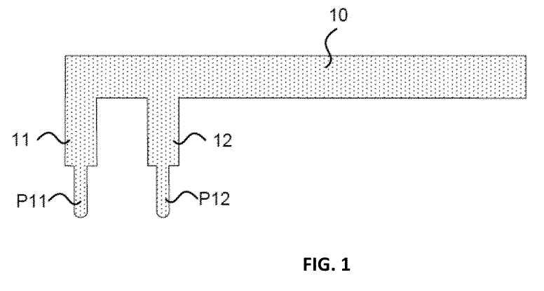

FIG. 2 is a 3D view of the inverted F antenna of FIG. 1 mounted on a printed circuit board;

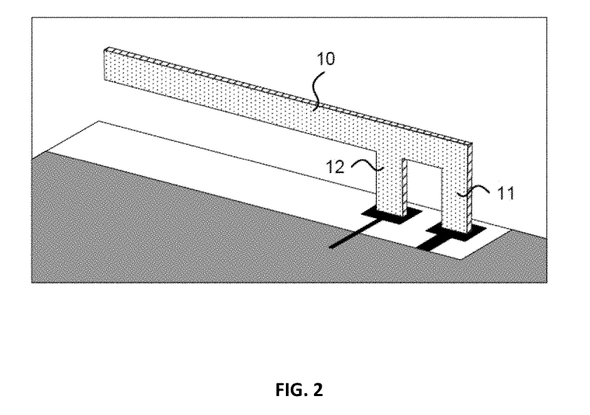

FIG. 3 is a first perspective view of an antenna system according to a first embodiment of the invention;

FIG. 4 is a second perspective view of the antenna system of FIG. 3;

FIG. 5 is a partial view of a printed circuit board whereon the antenna system of FIG. 3 and FIG. 4 can be mounted;

FIG. 6 is a view of the printed circuit board of FIG. 5 whereon the antenna system of FIG. 3 and FIG. 4 is mounted;

FIG. 7 is a diagram showing the reflection coefficient response of the antenna system of FIG. 3 and FIG. 4 mounted on the printed circuit board of FIG. 5;

FIG. 8 is a diagram showing the efficiency response of the antenna system of FIG. 3 and FIG. 4 in the bands [2.4 GHz-2.5 GHz] and [5.15 GHz-5.85 GHz];

FIG. 9 is a diagram showing the peak gain response of the antenna system of FIG. 3 and FIG. 4 in the bands [2.4 GHz-2.5 GHz] and [5.15 GHz-5.85 GHz];

FIG. 10 is a first perspective view of an antenna system according to a second embodiment of the invention mounted on a printed circuit board; and

FIG. 11 is a second perspective view of the antenna system of FIG. 10.

### 5. DESCRIPTION OF EMBODIMENTS

While example embodiments are capable of various modifications and alternative forms, embodiments thereof are shown by way of example in the drawings and will herein be described in details. It should be understood, however, that there is no intent to limit example embodiments to the particular forms disclosed, but on the contrary, example embodiments are to cover all modifications, equivalents, and alternatives falling within the scope of the claims.

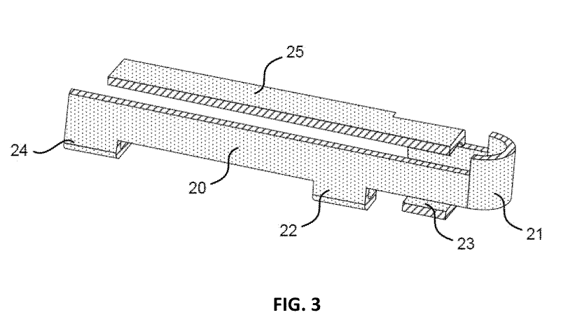

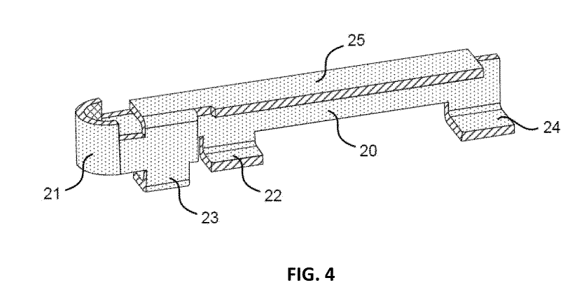

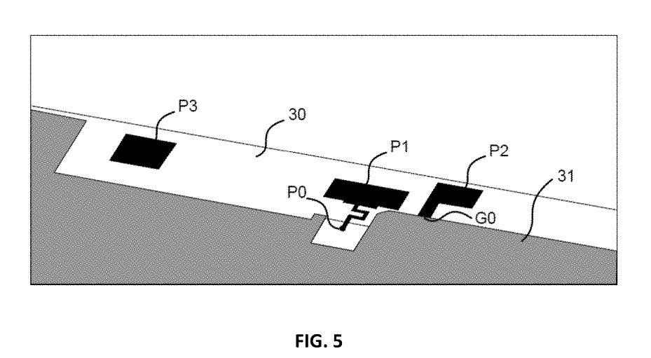

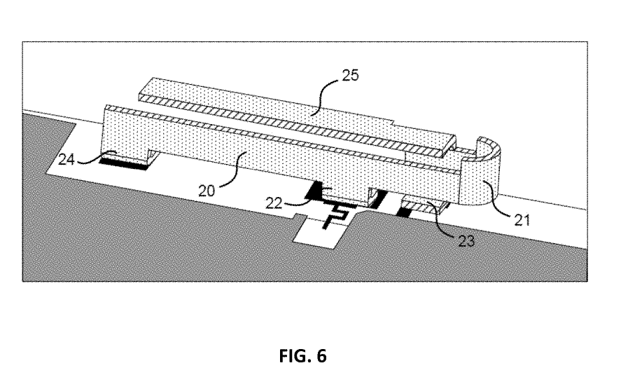

A first embodiment of the antenna system according to the invention is illustrated by FIGS. 3 and 4. This antenna system is mounted on a printed circuit board 30 as shown in FIGS. 5 and 6.

Referring to FIGS. 3 to 6, the antenna system comprises a vertical metal strip comprising a first portion, called radiating element 20 and a second portion, called radiating element 21. It further comprises three vertical metal strips, i.e. an antenna feeding element 22, a ground return element 23 and an open circuit element 24.

The radiating element 20 is connected, at a first end, to the upper end of the antenna feeding element 22 and, at a second end, to the upper end of the open circuit element 24. The lower end of the antenna feeding element 22 is connected to an antenna feeding pad P1 of the PCB and the lower end of the open circuit element 24 is connected to an open circuit pad P3 of the PCB. The radiating element 21 is connected, at a first end, to the upper end of the antenna feeding element 22 and, at a second end, to the upper end of the ground return element 23. The lower end of the ground return element 23 is connected to a grounding pad P2 of the PCB.

The grounding pad P2 is connected to a ground port G0 of a ground plane 31 of the PCB 30. The antenna feeding pad P1 is connected to a feeding port P0 of the PCB via a meander-shaped feeding line.

The radiating elements 20 and 21, the antenna feeding element 22 and the ground return element 23 are arranged to form an inverted-F antenna resonating at a first resonant frequency in a first frequency band, called B1. The total length of the elements 20, 21 and 23 is thus around a quarter of the wavelength associated to the first resonant frequency. The first resonant frequency is for example a frequency in the WiFi band [2.4 GHz-2.5 GHz].

In addition, the antenna feeding element 22, the radiating element 21 and the ground return element 23 are arranged to form a loop antenna resonating at a second resonant frequency in a second band frequency, called B2. The total length of the elements 22, 21 and 23 is thus around a half of the wavelength associated to the second resonant frequency. The band B2 is higher than the band B1. The second resonant frequency is for example a frequency in the WiFi band [5.15 GHz-5.85 GHz].

As illustrated in these figures, the radiating element 21 is advantageously U-shaped for compactness reason. The antenna feeding element 22, the ground return element 23 and the open circuit element 24 are preferably L-bended in order to reduce the height of the antenna system and to achieve a low-profile antenna design.

In a variant, the radiating element 20 is not connected to the open circuit element 24. In this case, one end of the radiating element 20 is open-ended.

In the illustrated antenna system, the main purpose of an open circuit element 24 is to better hold in place the antenna system on the PCB during the soldering process.

As shown in the FIGS. 3 to 6, the antenna system further comprises a third radiating element, referenced 25. A first end of the radiating element 25 is connected to the radiating element 21 and the other end is open-ended. The radiating elements 21 and 25, the ground return element 23 and the antenna feeding element 22 are arranged to form an inverted-F antenna resonating at a third resonant frequency in a third frequency band, called B3. The total length of the elements 21, 22 and 25 is thus around a quarter of the wavelength associated to the third resonant frequency.

In the case of a dual-band antenna, the third resonant frequency is included in the band B1 or in the band B2. The third resonant frequency is for example included in the WiFi band [2.4 GHz-2.5 GHz]. In that case, the third resonant frequency is close to the first resonant frequency in the band B1. It enables to increase the impedance matching bandwidth of the antenna system in the band B1.

The radiating element 25 is advantageously L-bended as illustrated by FIGS. 3 to 6. A portion of the L is plane and parallel to the surface of the printed circuit board. It enables to pick and place the antenna system by a machine for its connection to the printed circuit board 30.

The location and the size of the pads and the ports on the PCB are defined in order to optimize the operation of the antenna system. The size of the pad P1 has a sensitive influence on the antenna response in the band B2 (high band). Thus it can be optimized in order to improve the impedance matching in this band. In the same manner, the length, width and location parameters of the interconnection line printed between the pad P2 and the grounding port G0 is also a means to fine tune the antenna input impedance in the band B2.

The distance between the feeding port P0 and the grounding port G0 is also critical in the band B2 since it enables also to fine tune the antenna impedance matching in this band. Moreover, tuning the width of the feeding pad P1 has an effect on the antenna response in the band B2.

The antenna response in the low operation band B1 can be optimized in several ways:
by tuning the length and width of the radiating elements 20 and 25,
by adjusting the coupling (the air gap) between the radiating elements 20 and 21,
by tuning the impedance of the meander-shaped feeding line, from P0 to the pad P1.

The antenna system of FIGS. 3 to 6 has been designed for operating in the two WiFi bands [2.4 GHz-2.5 GHz] and [5.15 GHz-5.85 GHz]. The antenna system illustrated by these figures has the following sizes: length L=24.75 mm, width W=3.7 mm and height H=4.5 mm.

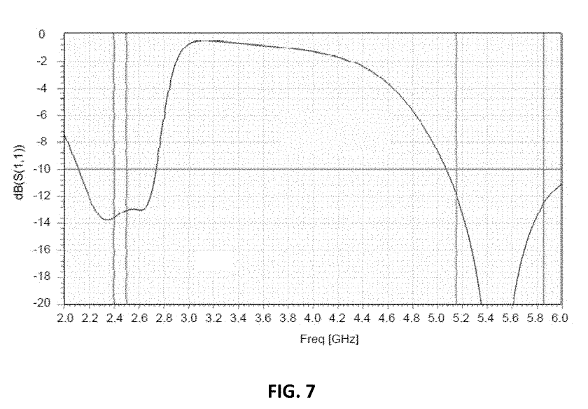

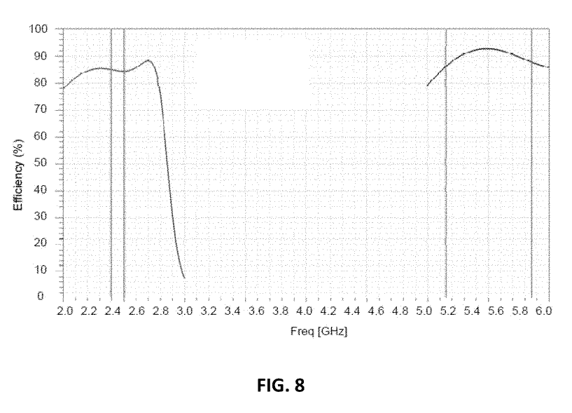

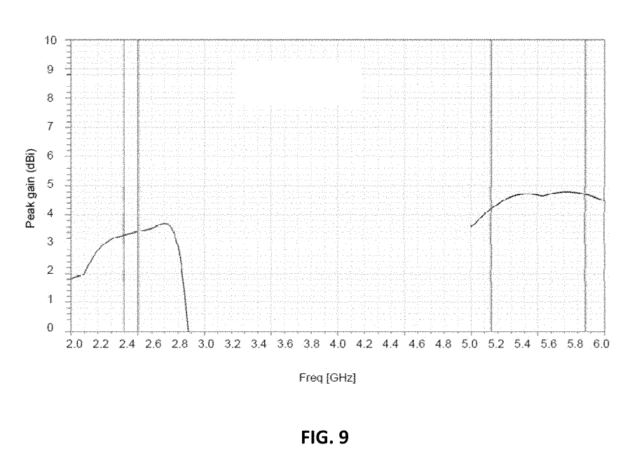

This antenna system mounted on a PCB and arranged within a housing has been simulated using the HFSS™ 3D electromagnetic simulation tool. The dimensions of the housing are: 85×85×15 mm³, and those of the PCB are 80*80*1.2 mm³. The PCB substrate is FR4 based. Simulation results are shown in the graphs of FIG. 7, FIG. 8 and FIG. 9.

FIG. 7 shows the return loss response of the antenna system. This graph shows that the antenna system is well matched in the both WiFi frequency bands [2.4 GHz-2.5 GHz] and [5.15 GHz-5.85 GHz].

The antenna efficiency plotted in FIG. 8 shows remarkable levels, higher than 85% in the worst case.

FIG. 9 shows the peak gain response in the two bands [2.4 GHz-2.5 GHz] and [5.15 GHz-5.85 GHz]. The achieved peak gains are around 2.5 dBi and 4.5 dBi in the bands [2.4 GHz-2.5 GHz] and [5.15 GHz-5.85 GHz] respectively.

These graphs show the good efficiency of the antenna system of FIGS. 3 to 6 in the bands B1 and B2.

Of course, this antenna design can also be arranged for working in three frequency bands B1 to B3. In that case, the radiating element 25 is sized in order to resonate in a band B3 located between B1 and B2 or lower than B1.

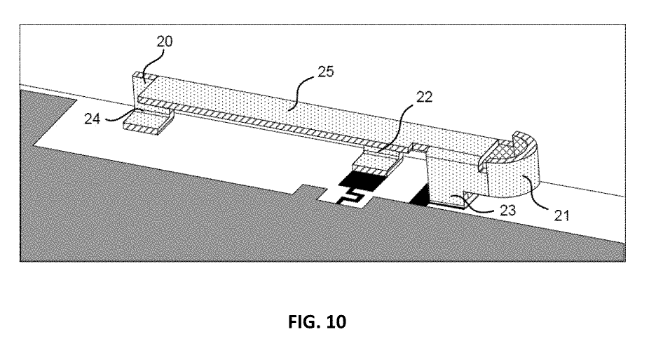

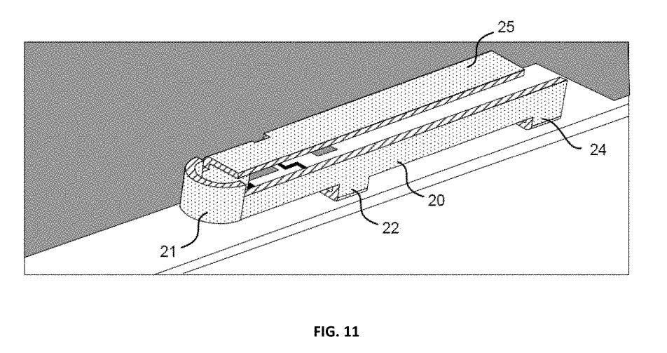

The antenna design can also be modified as shown in FIG. 10 and FIG. 11. In these figures, the radiating element 21 makes a U-turn on the right side (while it makes a U-turn on the left side in the embodiment of FIGS. 3 and 4).

This antenna system may be mounted on a printed circuit board of any type of home-networking devices, like set-top boxes, gateways or tablets.

1. An antenna system mounted onto a printed circuit board, said antenna system comprising:
a first radiating element having first and second ends,
an antenna feeding element connected, at a first end, to the second end of the first radiating element and, at a second end, to an antenna feeding pad of the printed circuit board,
a second radiating element having first and second ends, the first end of the second radiating element being connected to the second end of the first radiating element,
a ground return elements connected, at a first end, to the second end of the second radiating element and, at a second end, to a ground pad of the printed circuit board, and
a third radiating element (25) having first and second ends, the first end of the third radiating element being connected to the second end of the second radiating element,
wherein the third radiating element, the second radiating element, the ground return element and the antenna feeding element are arranged to form an inverted-F antenna.

2. The antenna system according to claim 1, wherein the first radiating element, the second radiating element, the antenna feeding element and the ground return element are arranged to form an inverted-F antenna resonating at a first resonant frequency in a first frequency band.

3. The antenna system according to claim 2, wherein the antenna feeding element, the second radiating element and the ground return element are arranged to form a loop antenna resonating at a second resonant frequency in a second frequency band.

4. The antenna system according to claim 3, wherein the second frequency band is higher than the first frequency band.

5. The antenna system according to claim 1, wherein the second radiating element is U-shaped.

6. Antenna system according to claim 1, wherein the antenna feeding element and the ground return element are L-bended.

7. The antenna system according to claim 1, wherein the third radiating element, the second radiating element, the ground return element and the antenna feeding element are arranged to form an inverted-F antenna resonating at a third resonant frequency in a third frequency band.

8. The antenna system according to claim 7, wherein the third frequency band is the first frequency band.

9. The antenna system according to claim 7, wherein third radiating element is L-bended, a portion of the L being parallel to the printed circuit board.

10. The antenna system according to claim 1, wherein the second end of the first radiating element is connected to an open circuit element.

11. A Device comprising:
a printed circuit board; and
an antenna system, said antenna system being mounted on said printed circuit board, the antenna system comprising:
a first radiating element having first and second ends,
an antenna feeding element connected, at a first end, to the second end of the first radiating element and, at a second end, to an antenna feeding pad of the printed circuit board,
a second radiating element having first and second ends, the first end of the second radiating element being connected to the second end of the first radiating element,
a ground return element connected, at a first end, to the second end of the second radiating element and, at a second end, to a ground pad of the printed circuit board, and
a third radiating element having first and second ends, the first end of the third radiating element being connected to the second end of the second radiating element,
wherein the third radiating element, the second radiating element, the ground return element and the antenna feeding element are arranged to form all inverted-F antenna.

12. The device according to claim 11 wherein the device is one of a gateway, a set-top box and a tablet device.
